(19) United States
(12) Patent Application Publication
(10) Pub. No.: US 2011/0252703 A1
(43) Pub. Date: Oct. 20, 2011

(54) Form for Shaping Culms

(75) Inventor: Alisa Paulsen Ramakrishnan, Vancouver (CA)

(73) Assignee: EMPIRE TECHNOLOGY DEVELOPMENT LLC, Wilmington, DE (US)

(21) Appl. No.: 12/854,746

(22) Filed: Aug. 11, 2010

(30) Foreign Application Priority Data
Apr. 15, 2010 (IN) 1060/CHE/2010

(51) Int. Cl. A01G 17/06; A01G 1/00

(52) U.S. Cl. 47/45; 47/44; 47/58.1 R

(57) ABSTRACT

A form for shaping a culm of a plant, such as bamboo, is provided. Embodiments of the form can comprise two interlocking corner pieces that can force the culm to grow in a square (or other multisided) shape. The interlocking corner pieces can be frictionally engaged, and the magnitude of the frictional force can be adjusted and optimized. The size of the form can then be automatically expandable, depending on the amount of friction placed on the interlocking corner pieces. In described embodiments, an optimized magnitude of frictional force can allow the form to expand if the culm is too large for the form (such as, for example, if the width of the form is set to be less than the actual width of the culm), while at the same time resisting such expansion enough to shape the culm as desired.

### CROSS-REFERENCE TO RELATED APPLICATIONS

This application claims priority to Indian Patent Application Serial No. 1060/CHE/2010 filed Apr. 15, 2010, the contents of which are incorporated by reference herein in its entirety.

### BACKGROUND

Bamboo is often used as a material of construction, and can be an excellent building material. Not only is bamboo a renewable resource that can be sustainably grown with a very short growth cycle, bamboo is also very durable and able to withstand high levels of mechanical stress. Bamboo naturally grows round, yet many of its applications, such as its use as a flooring material, require flat surfaces. Although bamboo is quite flexible, especially in its natural round state, such flexibility could be a detriment in some applications, such as the use of bamboo as support for a structure. A square shape may help limit such flexibility by providing corners to restrict the material from bending. To fabricate such flat bamboo surfaces, machining and/or other processing of the round bamboo is required, often requiring an undesired amount of steaming and laminating.

Bamboo has been and can be grown square, but the process can be stressful for the culm and can be labor-intensive. Indeed, some methods of squaring bamboo may induce high mortality rates and can be difficult to optimize, as well as relying heavily on user experience and requiring long training periods and a high level of skill. Forms are sized based on estimated culm diameter, and if the frame used to shape bamboo is too tight, the culm may be undesirably damaged or distorted. If the frame is not tight enough, the culm may not form into the desired shape.

### SUMMARY

Example embodiments provide for apparatuses and methods that can minimize worker training and maximize high-volume output of multisided culms. Example embodiments provide an apparatus for forming a culm comprising a first form and a second form, and an adjuster attached to the first form for exerting a resistive force on the second form.

Another embodiment provides for an apparatus for forming a culm comprising a first elongated member on which a first generally planar member is connected along a first plane; a second elongated member on which a second generally planar member is connected along a second plane, the second generally planar member slidingly engaging the first generally planar member; and an adjuster for exerting a first resistive force on the second generally planar member, the adjuster disposed on the first elongated member.

Another embodiment provides a method for forming a multisided culm, the method comprising positioning a first corner form and a second corner form around a culm to form a multisided form around the culm; causing the first corner form to exert a resistive force on the second corner form; and adjusting the magnitude of the resistive force.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Example embodiments are described herein with reference to the drawings, in which:

FIG. 1 is a perspective view of an illustrative embodiment;

FIGS. 1A and 1B are alternate detail views of a portion of the embodiment shown in FIG. 1;

FIG. 2 is a perspective view of an illustrative embodiment;

FIGS. 2A-2C are detail views of a portion of an embodiment similar to that shown in FIG. 2;

FIG. 3 is a perspective view of an illustrative embodiment;

FIG. 3A is a perspective view of an illustrative embodiment with guy wires;

FIG. 4 is a perspective view of an illustrative embodiment;

FIG. 4A is a detail view of a portion of the embodiment shown in FIG. 4;

FIG. 5 is a top view of a four-sided illustrative embodiment;

FIG. 6 is a top view of a six-sided illustrative embodiment;

FIG. 7 is a top view of a five-sided illustrative embodiment;

FIG. 8 is a top view of a three-sided illustrative embodiment;

FIG. 9 is a top view of an illustrative mechanism for squaring a form;

FIG. 9A is a detail view of an illustrative embodiment of the arrangement shown in FIG. 9; and

FIG. 10 is a flow chart depicting steps of a method performed in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and are made part of this disclosure.

An embodiment provides a form for shaping a culm of a plant, such as bamboo. The form is placed on the ground above an emerging culm and extends vertically upward from the ground. Embodiments described below can optimize squaring by limiting stresses on the culm, such as light-starvation and mechanical stress. In addition, below described embodiments incorporate standardized sizing materials that can be automatically adjusted to optimize squaring for each culm, are reusable, and are automatically adjustable. Further, embodiments herein allow light to penetrate for photosynthesis, reducing stress on the growing culm and potentially allowing a greater percentage of culms to reach maximum height. Moreover, methods and apparatuses described herein for optimizing the growth of multisided culms can decrease the cost of bamboo building materials.

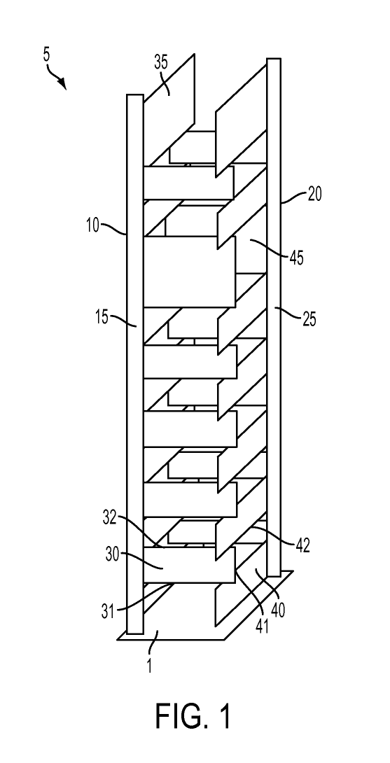

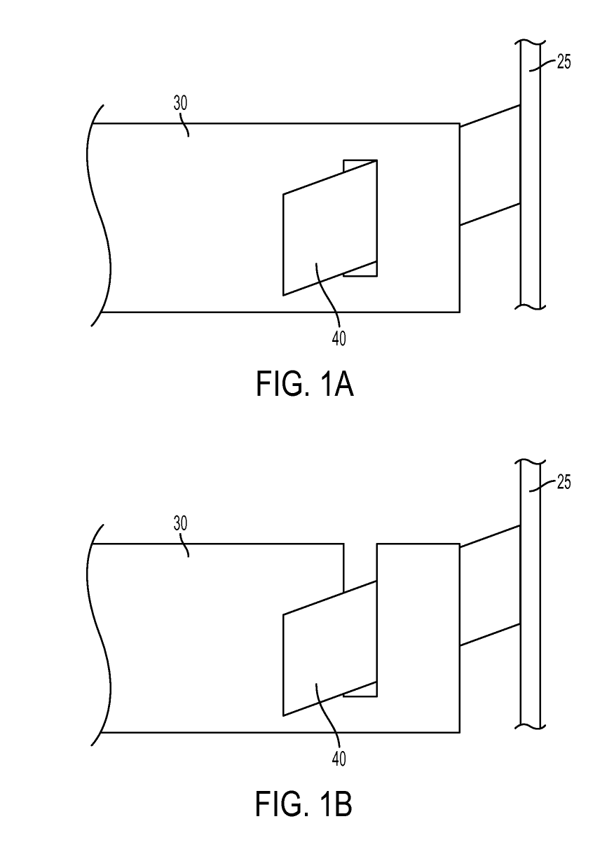

An example form 5 for shaping multisided culms is depicted in FIGS. 1-4. The form 5 can comprise two or more corner forms, such as a first corner form 10 and a second corner form 20, which can be placed together on the ground 1 as depicted in FIG. 1. Each corner form can comprise an elongated member, such as a first elongated member 15 and a second elongated member 25, extending from approximately the bottom of the form 5 to the top of the form 5. Each elongated member can serve generally to hold each corner form vertically above the ground and to support other components located on the corner form.

Further, each elongated member can have a cross-sectional shape, with many such shapes being possible. Examples of such cross-sectional shapes include circular, oval, square, or other multisided shapes, any of which may be solid rods or bars, or hollow tubes or pipes, for example. Other examples include corner pieces, such as a square or structural corner angle, for example. The angle of the corner piece may be a 90 degree angle, although other corner angles are possible, as well.

The corner forms 10 and 20 may be made from any material or any combination of materials, including wood, plastic, or metal, such as, for example, extruded aluminum. The selection of the shape of the elongated members may be based on available materials, the cost of manufacture or fabrication, and/or an ability to better shape a culm, for example. Depending on the design of the form 5, in an embodiment a square corner angle may shape a culm.

The corner forms 10 and 20 and associated components can be mass-produced in a machine shop. In an example embodiment, the height of the form 5 can be six to ten feet high, and can depend on the height of the culm to be formed. The width of the form 5 can vary, but will likely not exceed a maximum of ten inches on each side for bamboo applications. In an example embodiment, each corner form can be identical.

Each of the first corner form 10 and the second corner form 20 can comprise one or more generally planar members. As depicted in FIG. 1, the first corner form 10 may include first generally planar members 30 and second generally planar members 35, and the second corner form 20 may include third generally planar members 40 and fourth generally planar members 45. In such a case, each generally planar member has an interior surface that contacts a culm. If generally planar, the interior surface can form the culm into a corresponding generally planar surface.

As depicted, each set of generally planar members can form a plane along which the exterior surface of the culm can be formed as it expands and contacts the generally planar members. Accordingly, the first generally planar members 30 can form a first plane, the second generally planar members 35 can form a second plane, the third generally planar members 40 can form a third plane, and the fourth generally planar members 45 can form a fourth plane.

In the depicted embodiments, each generally planar member also has a planar exterior surface opposite the interior surface. The exterior surface can be any shape, however, and, generally, the generally planar members can be any shape, profile, or cross-section. Example exterior surface shapes and planar member shapes include but are not limited to the following: rectangular, semi-circular, and flat. As depicted, each generally planar member also includes an edge surface, such as a first bottom edge surface 31 and a first top edge surface 32 of one of the generally planar members 30 and a second top edge surface 41 and a second bottom edge surface 42 of one of the generally planar members 40.

The generally planar members of the first corner form 10 can engage the generally planar members of the second corner form 20. In particular, as depicted in FIG. 1, the first generally planar members 30 (of the first corner form 10) can engage the third generally planar members 40 (of the second corner form 20). Likewise, the second generally planar members 35 (of the first corner form 10) can engage the fourth generally planar members 45 (of the second corner form 20). In each case, all or just a portion—of the generally planar members of a corner form can engage other generally planar members.

In an embodiment, the generally planar members are slidingly engaged. Referring to FIG. 1, the first generally planar members 30 (of the first corner form 10) can engage the third generally planar members 40 (of the second corner form 20). Likewise, the second generally planar members 35 (of the first corner form 10) can engage the fourth generally planar members 45 (of the second corner form 20). In particular, corresponding edge surfaces of the generally planar members, such as the first bottom edge surface 31 and the second top edge surface 41, can slidingly engage or cooperate.

Generally, embodiments provide an engagement between the first corner form 10 and the second corner form 20 that both (i) allows for enough expansion of the form 5 to compensate for the width of the form being set to be less than the actual width of the culm, and (ii) resists expansion of the culm enough to shape the culm as desired. In particular, the engagement between the first corner form 10 and the second corner form 20 allows for relative movement between the first corner form 10 and the second corner form 20. Such movement is advantageous because it allows the form 5 to expand if the culm is too large for the form (such as, if the width of the form is set to be less than the actual width of the culm). Moreover, the ability of the form 5 to expand allows the user to make the form 5 smaller, reducing or eliminating the need to precisely estimate the final width of the culm. The resulting culm would then be more regularly square instead of sometimes square and sometimes distorted, such as by being curved inward or outward.

Accordingly, the engagement between the first corner form 10 and the second corner form 20 is not limited to a sliding engagement or to the particular depicted sliding engagement. The form 5 can include any engagement that allows for some relative movement between the first corner form 10 and the second corner form 20. For example, the first generally planar surfaces 30 and the second generally planar surfaces 40 can have a slotted engagement where the edge surfaces meet, and examples of such engagements are depicted in FIGS. 1A and 1B. Other examples are possible as well.

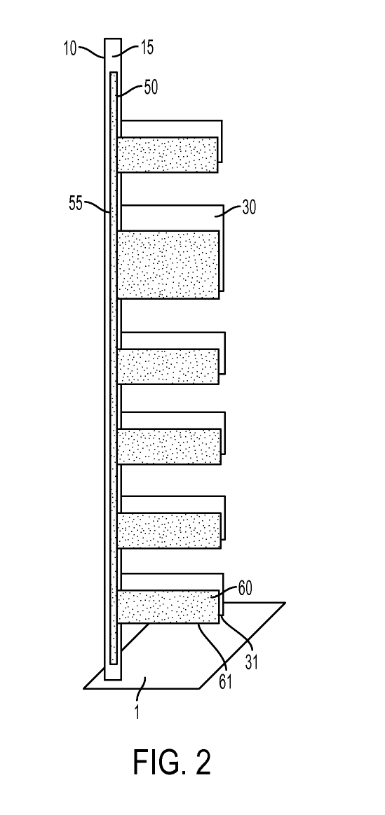

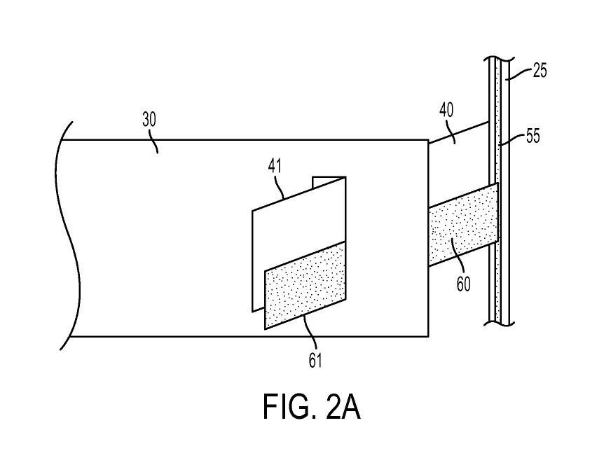

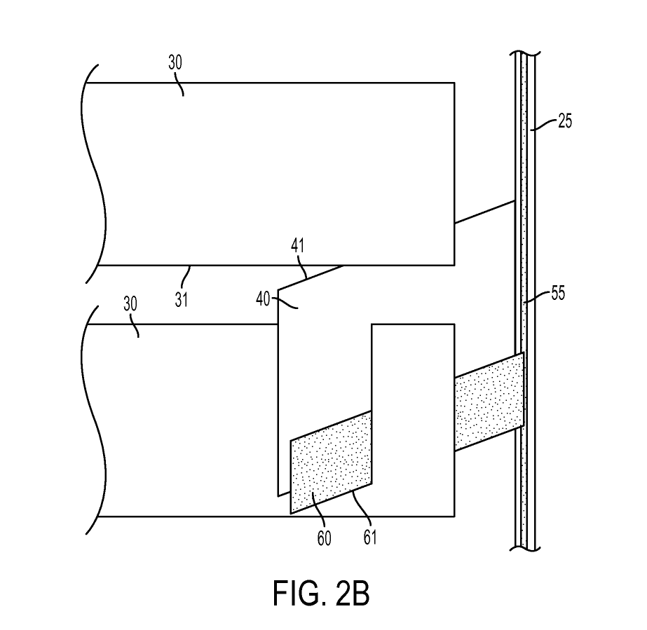

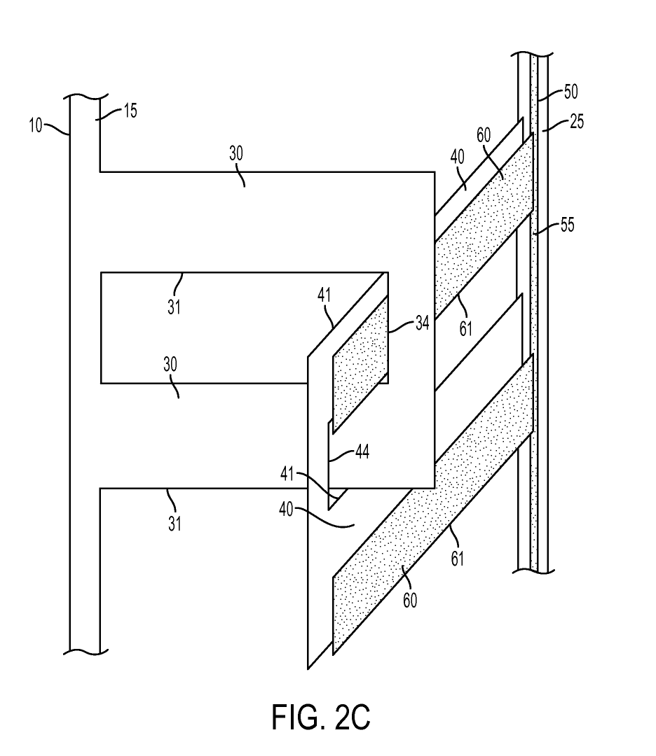

The engagement between the first corner form 10 and the second corner form 20 provides some resistance to expansion in the form of friction between, for example, the engaging edge surfaces of the generally planar members. In some embodiments, the amount of friction between the engaging edge surfaces can be increased and adjusted through an adjuster 50, as depicted in FIG. 2. As depicted in FIG. 2, the adjuster 50 can comprise an elongated member 55 and one or more generally planar surfaces 60. The adjuster 50, as well as the elongated member 55 and the one or more generally planar surfaces 60, can correspond to a corner form and its respective elongated member and at least some of its generally planar surfaces. The adjuster 50 can provide resistance to expansion by exerting downward, and corresponding upward, forces on engaging edge surfaces of the first corner form 10 and the second corner form 20. Other examples are possible as well.

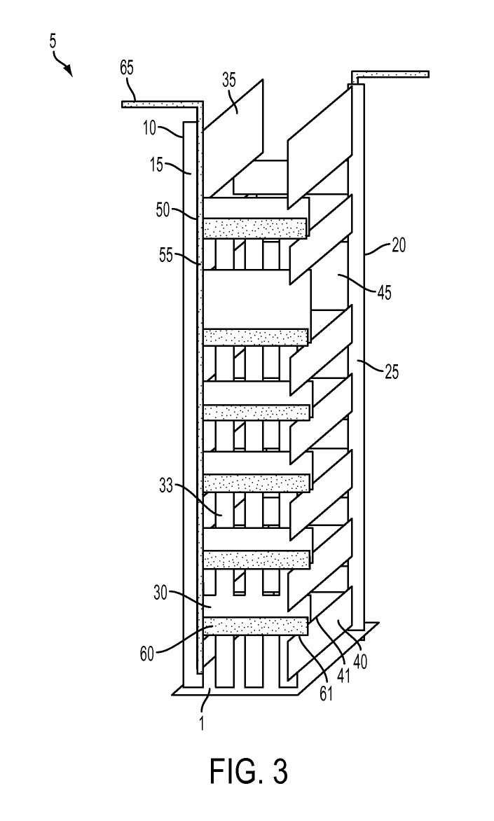

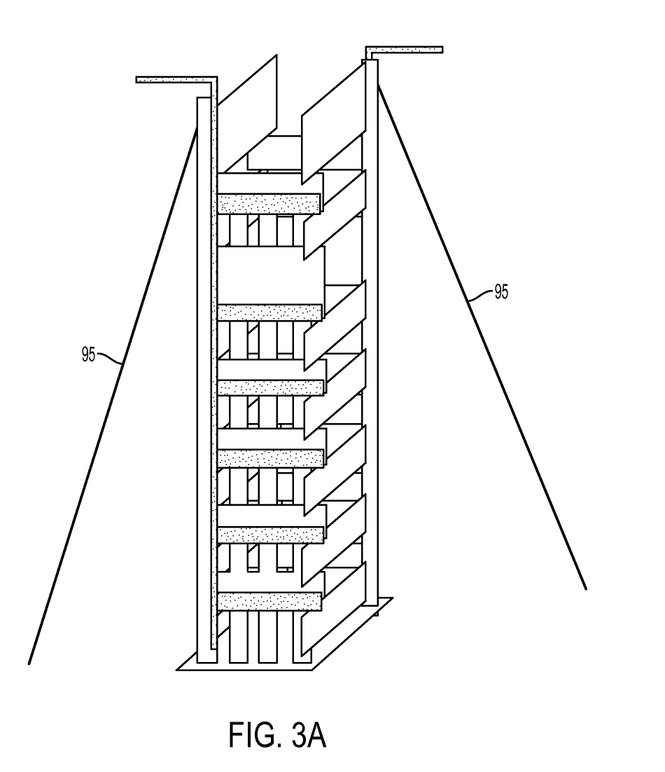

As depicted in FIG. 2, the adjuster 50 corresponds and is generally aligned with the corner faun 10, the elongated member 55 corresponds to the first elongated member 15 of the corner form 10, and the one or more generally planar surfaces 60 correspond to the first generally planar surfaces 30 of the corner form 10. As also depicted in the example of FIG. 2, the one or more generally planar surfaces 60 may have a shape that is similar to or that corresponds with the shape of the first generally planar surfaces 30 of the corresponding corner form. As depicted in FIG. 3, however, the one or more generally planar surfaces 60 may have a shape that differs from the shape of the first generally planar surfaces 30 of the corresponding corner form. In addition, as depicted in FIGS. 2-4, the generally planar members of the adjuster 50 can form a plane substantially parallel to, and nearly coplanar with, the first plane formed by the first generally planar member 30.

Moreover, as depicted in both FIGS. 2 and 3, the bottom edges of the generally planar surfaces 60 of the adjuster 50 (such as the bottom adjuster edge 61) are slightly downwardly offset—or lower than—the bottom edges of the generally planar surfaces 30 of the first corner form 10 (such as the first bottom edge 31). Accordingly, and as depicted in FIGS. 2 and 3, the adjuster 50 can engage or contact the second corner form 20 in much the same way as FIG. 1 depicts the first corner form 10 engaging or contacting the second corner form 20.

Although not required, in the embodiments depicted in FIGS. 2 and 3, the generally planar members are slidingly engaged. As such, the generally planar members 60 (of the adjuster 50) can engage the third generally planar members 40 (of the second corner form 20). In particular, corresponding edge surfaces of the generally planar members, such as the adjuster edge surface 61 and the second top edge surface 41, can slidingly engage or cooperate.

The adjuster 50, and, in some embodiments, the elongated member 55, can comprise a mechanism to increase the friction and, hence, the resistance to expansion, between the first corner form 10 and the second corner form 20. Generally, to increase the friction between the corner forms, friction between corresponding edge surfaces, such as the first bottom edge surface 31 or the adjuster edge surface 61 and the second top edge surface 41, is increased. One way to do so is depicted in FIGS. 2-4, which show the offset between the bottom edge surfaces of the adjuster 50 and the bottom edge surfaces of the first corner form 10.

Accordingly, in this depicted embodiment, the top edge surfaces of the second corner form 20 would actually contact the bottom edge surfaces of the adjuster 50—not the bottom edge surfaces of the first corner form 10. In particular, although the first corner form 10 slidingly engages the second corner form 20 and at least one first generally planar member 30 slidingly engages at least one third generally planar member 40, the top edge surfaces of the generally planar members of the second corner form 20 contact the bottom edge surfaces of the generally planar members 60 of the adjuster 50. The bottom edge surfaces of the third generally planar members 40 can still contact the top edge surfaces of the first generally planar members 30, however.

Accordingly, one method of increasing the friction between corresponding edge surfaces is to increase the offset between the edge surfaces of the adjuster 50 and the edge surfaces of the first corner form 10. In other words, if the vertical positions/heights of the first corner form 10 and the second corner form 20 remained relatively unchanged, an increase in the offset between the adjuster 50 and the first corner form 10 would increase the downward force of the adjuster 50 on the second corner form 20, and can also increase the upward force of the first generally planar members 30 on the third generally planar members 40. Likewise, a decrease in the offset between the adjuster 50 and the first corner form 10 would decrease the downward and upward, or frictional or resistive, force between those components. Although depicted as a downward offset in the Figures, embodiments with an upward offset are possible as well.

In response to an increased frictional force between the adjuster 50 and the second corner form 20, the form 5 will increase its resistance to expansion of a culm. Similarly, in response to a decreased frictional force between the adjuster 50 and the second corner form 20, the form 5 will decrease its resistance to expansion of a culm. In addition, similar to the adjuster 50 shown in FIGS. 2-4, the second corner form 20 can also include an adjuster, and that adjuster can work in much the same way as the adjuster 50. A user can use both adjusters to optimize, or increase or decrease, a form's resistance to expansion of a culm.

Other example arrangements of the adjuster 50 are depicted in FIGS. 2A-2C, which each show an example arrangement in which the adjuster 50 is disposed on the second elongated member 25. In each, expansion of a culm can be limited in one or more directions due to the engagement between the first corner form 10 and the second corner form 20. FIGS. 2A and 2B depict examples in which the first corner form 10 and the second corner form 20 are engaged via a slotted connection. In such an example, expansion along the plane defined by the first generally planar surface 30 is limited by the location of the slot that receives the third generally planar surface 40, and the distance that slot is from the first elongated member 15. FIG. 2C depicts an example embodiment in which the corner form 10 is connected to the corner form 20. In this example, expansion along the planes defined by the first generally planar surfaces 30 and the third generally planar surfaces 40 are limited by the distance a first side edge surface 34 and a second side edge surface 44 are from the first elongated member 15 and the second elongated member 25, respectively. Other examples are possible as well.

The adjuster 50 can comprise any components needed to adjust the resistance to expansion of the form 5, for example, by increasing or decreasing the offset between the edge surfaces of the adjuster 50 and the edge surfaces of the first corner form 10. In one embodiment, the adjuster 50 comprises a screw mechanism to adjust the amount of friction between the first corner form 10 and the second corner form 20. In such an embodiment, the screw mechanism can be screwed inwards or outwards (or downwards or upwards, respectively), moving the elongated member 55 and the generally planar members 60 downwards or upwards. The downward or upward movement then, respectively, increases or decreases the offset between the bottom edge surfaces of the adjuster 50 and the edge bottom surfaces of the first corner form 10.

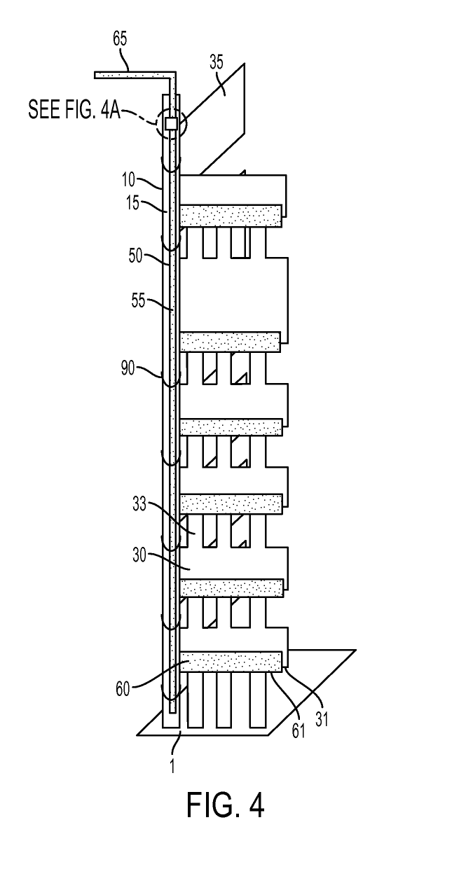

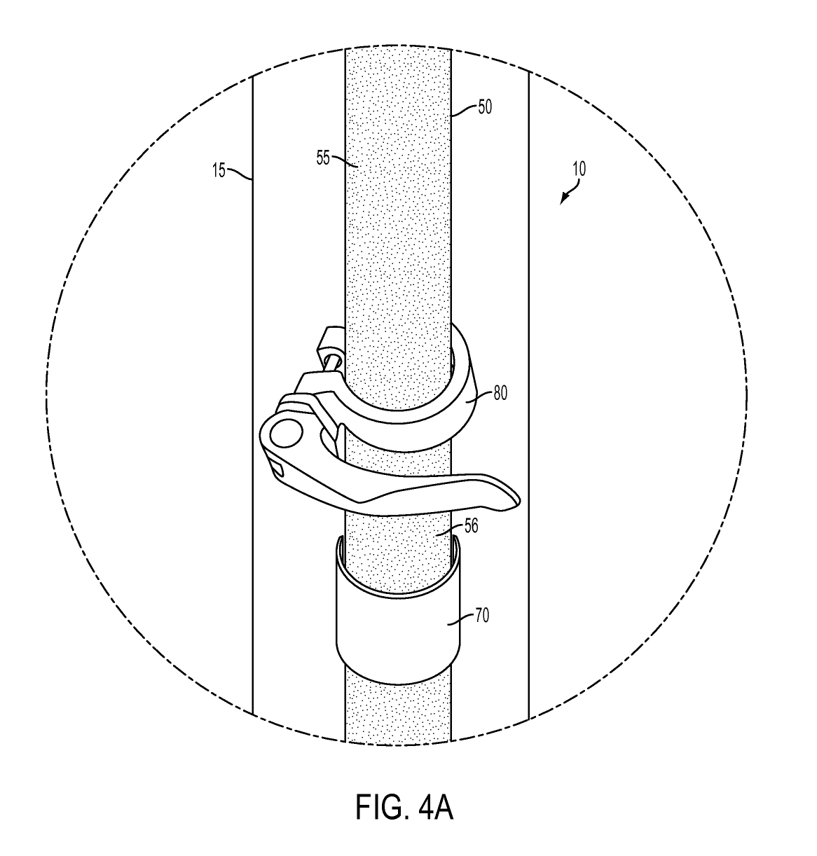

In other embodiments, the adjuster 50 can comprise a sliding/locking mechanism to move the elongated member 55 and the generally planar members 60 downwards or upwards, thereby increasing or decreasing the offset. In such embodiments, the elongated member 55 and the generally planar members 60 can slide downwards or upwards, and then lock into a desired position. In any embodiment, the adjuster 50 may also include a component, such as a handle 65, to facilitate adjustment of the offset or resistive force. Although shown at the top of the elongated member in FIGS. 3 and 4, the handle 65 may be located at any suitable height along the length of the elongated member 55.

In still other embodiments, the adjuster 50 can comprise a tension rod, which may, for example, comprise two elongated members such as rods, with a portion of one inside each the other. The adjuster 50 can then also include a mechanism for adjusting the tension of the rods. As an example, one of the two elongated members can be held fixed axially, while the other elongated member can be spring biased to provide an offset and resulting force, which in some cases may be predetermined based on the strength of the spring. As another example, one of the two elongated members can be held fixed axially, while the other elongated member can be threaded into and out of (or upwards or downwards relative to) the fixed elongated member to provide an offset and resulting force.

FIGS. 4 and 4A depict another example embodiment, in which the first elongated member 15 of the first corner form 10 includes an internally threaded collar 70, which is fixed on the first elongated member 15 and which can receive an externally threaded portion 56 of the elongated member 55. In this example, the elongated member 55 can be threaded downwards or upwards relative to the fixed threaded collar 72, respectively increasing or decreasing the offset and resulting force. Other combinations of elements are possible as well. FIG. 4 also depicts one or more attachment straps 90 for attaching the adjuster 50 to the elongated member 15 of the first corner form 10. The attachment straps 90 may be, in some embodiments, plastic straps similar to wire ties. In other embodiments, the attachment straps may be metal, plastic, or rubber bands. Other examples and ways of attaching, such as by forming the elongated member 55 into or integrally with the first elongated member 15, are possible as well.

FIG. 4A also depicts an example component, a quick-release fastener 80, for holding the elongated member 55 of the adjuster 50 at the desired offset and resulting force. The fastener 80 can be fixedly attached to the first elongated member 15 of the first corner form 10. When a user wishes to adjust the offset/force of the adjuster 50, he or she can release the fastener 80 and thereby allow elongated member 55 to rotate and/or move axially. A fastener 80, or similar component, can also be used with other embodiments of the adjuster 50, in addition to the embodiment depicted in FIGS. 4 and 4A.

As depicted in FIGS. 1-4, the form 5, and in particular the generally planar elements, may not cover the entire culm. Such a construction allows light to enter to allow photosynthesis and healthy bamboo growth, as well as makes the forms lighter weight and provides openings through which to view the culm. Some embodiments, as depicted in FIG. 3, can include one or more vertical slats 33. The one or more vertical slats 33 can help encourage square growth of the culms throughout the culm's length. More particularly, the one or more vertical slats 33 can discourage non-square sections that could occur or fowl in spaces where the generally planar surfaces do not cover the entire culm.

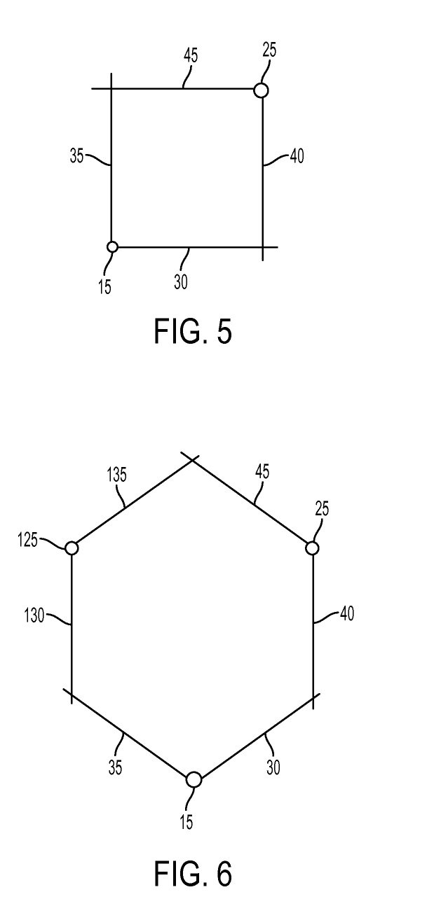

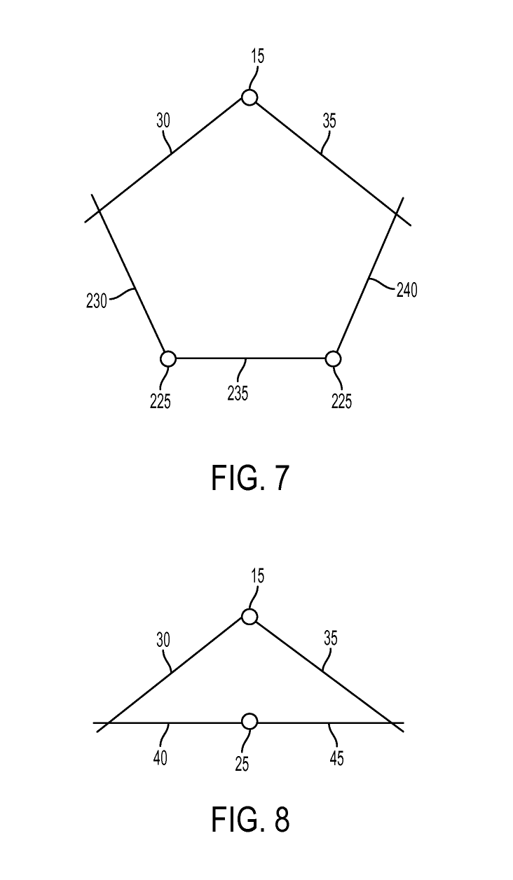

Although FIGS. 1-4A depict embodiments for forming square or quadrangular culms, forms for non-square and non-quadrangular shaped culms are possible and envisioned within the scope of the present disclosure. FIGS. 5-8 depict top cross-sectional views of example apparatuses for forming multisided culms. FIG. 5 depicts a square or 4-sided form that includes the first elongated member 15 and generally planar members 30 and 35 engaging the second elongated member 25 and generally planar members 40 and 45. FIG. 6 depicts an example of a six-sided form that includes an additional elongated member 125 and additional generally planar members 130 and 135. FIG. 7 depicts an example of a five-sided form that includes additional elongated members 225 and additional generally planar members 230, 235, and 240. And FIG. 8 depicts an example of a three-sided form using the first elongated member 15 and generally planar members 30 and 35 engaging a differently configured second elongated member 25 and generally planar members 40 and 45. Other embodiments are possible as well. And although depicted as round, the elongated members shown in FIGS. 5-8 can be any shape, as discussed above.

In operation, a user can identify a culm as it first emerges from the ground 1. A user can then place the corner forms to be used, such as the first corner form 10 and the second corner form 20, around the culm, making the width of the form 5, in one arrangement, about one to two inches smaller than the expected maximum diameter of the culm. The expected maximum diameter of the culm can be based on species information and prior knowledge, for example. A user can then string guy lines 95 attached to the form 5 and the ground 1, to keep the form 5 stable and to minimize a risk of falling (see FIG. 3A). Once the culm has grown to an acceptable size and/or diameter, the user can remove the foam and let the wood cure for however long a particular species needs. As an example, the Moso species of bamboo needs to cure for three years.

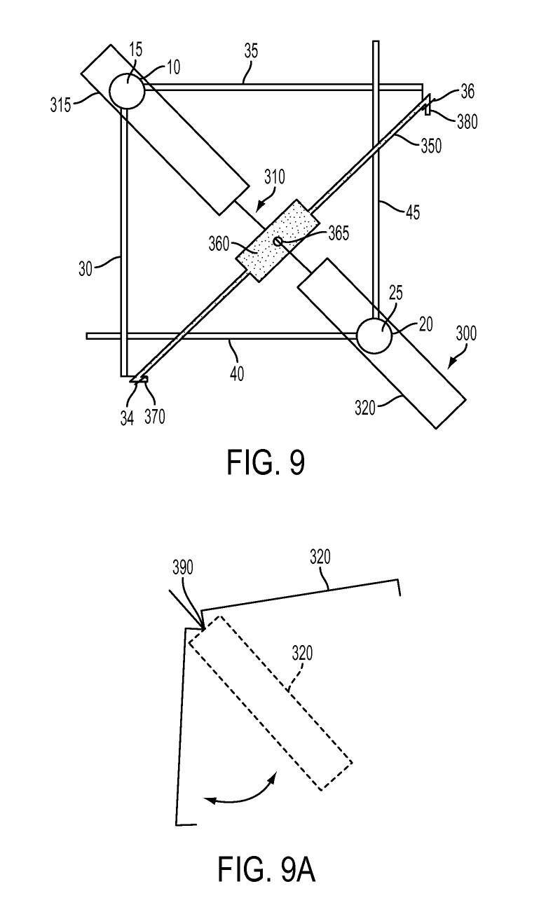

FIG. 9 depicts an example squaring mechanism 300 for use in setting the fowl 5 in a square shape to produce square-shaped culms. The example squaring mechanism 300 depicted in FIG. 9 can comprise two principal members—a first squaring member 310 and a second squaring member 350. In some embodiments, the first squaring member 310 can comprise a first slot 315 and a second slot 320. As depicted in FIG. 9, the first slot 315 can engage the first elongated member 15 and the second slot 320 can engage the second elongated member 25, and can allow relative movement between the slots and the elongated members along the length of the slots. In other embodiments, the first squaring member 310 may only include one slot, such as the second slot 320, while engaging the first elongated member 15 via a non-slotted connection. Such a non-slotted connection would restrict relative lateral or horizontal movement between the first elongated member 15 and the non-slotted connection (although relative rotational movement may be allowed).

The second squaring member 350 can comprise a first hook 370 and a second hook 380. As depicted in FIG. 9, some embodiments of the generally planar members, such as one or more first generally planar members 30 and one or more second generally planar members 35, can include a first hook 34 and a second hook 36 disposed at, for example, an outside edge of each respective member. Accordingly, the second squaring member 350 can engage the first corner form 10 via the engagement of each respective hook, as depicted in FIG. 9. For example, the first hook 370 of the second squaring member 350 can engage the first hook 34 of a first generally planar member 30, and the second hook 380 of the second squaring member 350 can engage the second hook 36 of a second generally planar member 35. The second squaring member 350 can also comprise a middle portion 360, which can include an opening 365 or other mechanism for slidingly engaging the first squaring member 310. The opening 365 can be located at the center of the length of the second squaring member 350, to facilitate squaring of the form.

In use, a user can place the squaring mechanism 300 on the form 5. In one example, the user can place the squaring mechanism 300 on the top of the form 5, such that the first elongated member 15 is placed through the first slot 315 and the second elongated member 25 is placed through the second slot 320. The first hook 370 and the second hook 380 of the second squaring member can also be hooked onto the first hook 34 and the second hook 36 of the first corner form 10, respectively. In an example embodiment, the user can adjust the position of the second corner form 20 by sliding the second elongated member 25 along the second slot 320. Because of the fixed engagement between the second squaring member 350 and the first corner form 10 (i.e., there is no relative movement between the second squaring member 350 and the first corner form 10 once engaged), and because the first squaring member 310 slidingly engages the second squaring member 350 at the center of the length of the second squaring member 350, locating the second elongated member 20 along the second slot 320 can facilitate squaring the form 5.

FIG. 9A depicts a detailed view of one example embodiment of the squaring mechanism 300. In this embodiment, one or both of the first slot 315 and the second slot 320 can include a hinge, such as the hinge 390 depicted in FIG. 9A (showing the second slot 320). The hinge 390 can allow the slotted members to be opened for placement around the first elongated member 15 and the second elongated member 25. A user can then place the squaring mechanism at locations along the height of the form 5, and not just over the top of the form 5, by (i) opening the hinged slotted members, (ii) positioning the squaring mechanism as appropriate at a location along the height of the form 5, and then (iii) closing the hinged slotted members. The user can then adjust the position of the second corner form 20 by sliding the second elongated member 25 along the second slot 320, as described above.

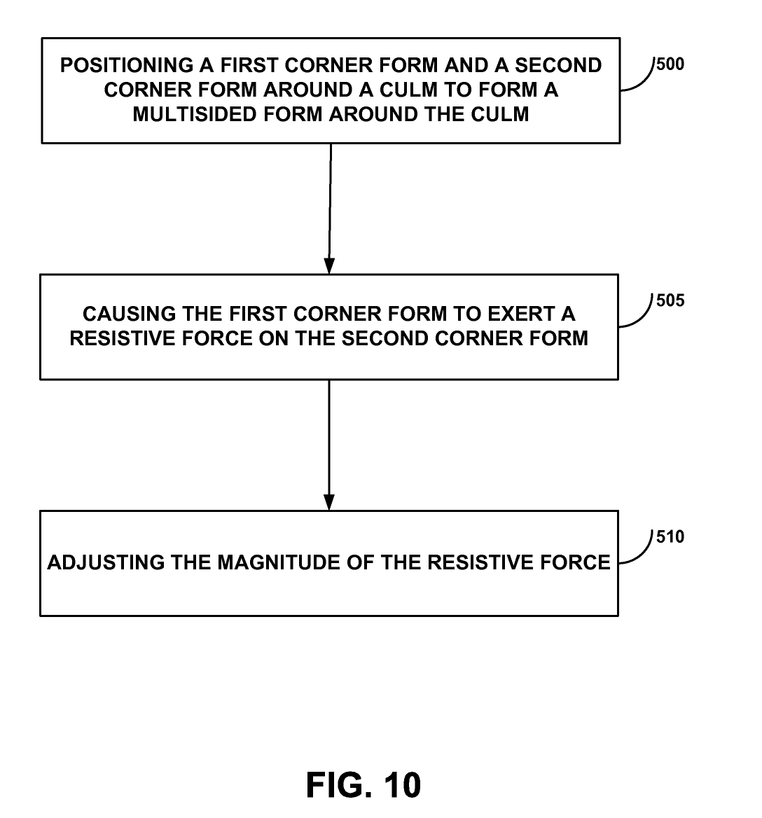

FIG. 10 sets forth a flowchart that depicts steps of a method performed in accordance with an embodiment. At step 500 of FIG. 10, a user positions a first corner form and a second corner form around a culm to form a multisided form around the culm. As discussed, the multisided form can be smaller than an expected maximum diameter of the culm. At step 505, a user causes the first corner form to exert a resistive force on the second corner form. As described above, in an example embodiment, the first corner form 10 can exert a resistive force on the second corner form 20 via the engagement of the generally planar members 55 of the adjuster 50 with the generally planar members 40 of the second corner form 20. Then, at step 510, a user adjusts the magnitude of the resistive force.

The form is then left in place and the culm is forced to grow in a square (or other multisided) shape. The size of the form is automatically adjustable, depending on the amount of friction placed on the interlocking corner pieces, which can be adjusted using the adjuster 50 as described above. In example embodiments, if the amount of friction is optimized correctly, the form 5 should be able to expand if the culm is too large for the form, such as, for example, if the width of the form is set to be less than the actual width of the culm, while at the same time resisting such expansion enough to form the culm as desired.

Determining the appropriate amount of friction will likely depend on a combination of factors, including an assessment of the species being formed and the environment in which it is growing. Indeed, tests on the appropriate amount of friction may need to be conducted to collect data on the factors affecting culm growth. Once an appropriate amount of friction is determined, then the same amount of friction could be applied to all related plants. To facilitate repeatable and predictable results, markings could be noted on the corner foams and/or the adjuster 50 instructing the user on the appropriate offset and/or resulting force for a particular species, environment, etc.

Embodiments disclosed herein should allow the user to make the width of the form less than a maximum expected width (or diameter) of a culm, instead of having to precisely estimate the final width of the culm. Such an arrangement can make the resulting bamboo more regularly square instead of sometimes square and sometimes curved inward or outward, as can be found in known methods of forming. In accordance with embodiments provided herein, the width of a form used to square a new culm can match as closely as possible to the width of the culm underground, before emergence above the soil.

Fabrication and processing time for culms formed pursuant to described embodiments can be shorter because a step of opening up a circular shape may be largely avoided. In addition, some applications call for the use of a square or rectangular shaped culm—for example, a square or rectangular culm with corners can be used to make the leg of a table or a wall support. Moreover, a square or rectangular culm may be sturdier than a bendable round shape, and may be stronger for some uses than a round shape. Further, to increase material available for planar-surface building material, culms can be grown in a rectangular shape instead of square, such as in the shape of a standard 2×4.

Additional features of the present invention include, but are not limited to, convenience, ease of use, sturdiness, reliability, portability, and efficiency.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. An apparatus for forming a culm comprising:
a first form and a second form; and
an adjuster attached to the first form for exerting a resistive force on the second form.

2. The apparatus of claim 1, the first form further comprising:
a first corner form comprising:
a first elongated member,
a first generally planar member fixedly connected to the first elongated member along a first plane, and
a second generally planar member fixedly connected to the first elongated member along a second plane: and
the second form further comprising:
a second corner form, the second corner form comprising:
a second elongated member;
a third generally planar member fixedly connected to the second elongated member along a third plane; and
a fourth generally planar member fixedly connected to the second elongated member along a fourth plane; and
wherein the first corner form slidingly engages the second corner form such that the first generally planar member slidingly engages the third generally planar member; and
wherein the adjuster exerts the resistive force on the third generally planar member.

3. The apparatus of claim 2, wherein the first generally planar member, the second generally planar member, the third generally planar member, and the fourth generally planar member form a multisided form around the culm.

4. The apparatus of claim 3, wherein the culm comprises a maximum expected diameter and the multisided form is smaller than the expected maximum diameter of the culm.

5. The apparatus of claim 3, wherein the culm comprises a diameter that can be formed into a multisided shape, and the resistive force causes the multisided form to resist the expansion of the diameter of the culm.

6. The apparatus of claim 5, wherein the multisided form expands when resisting the expansion of the diameter of the culm.

7. The apparatus of claim 1, wherein the adjuster adjusts the magnitude of the resistive force.

8. The apparatus of claim 2, wherein the adjuster comprises a fifth generally planar member slidingly engaging the third generally planar member, the fifth generally planar member being disposed along a fifth plane that is substantially parallel to the first plane.

9. The apparatus of claim 2, wherein the adjuster comprises a first bottom edge surface and wherein the first generally planar member comprises a second bottom edge surface, and wherein the first bottom edge surface of the adjuster is offset from the second bottom edge surface of the first generally planar member.

10. The apparatus of claim 9, wherein the offset between the first bottom edge surface of the adjuster and the second bottom edge surface of the first generally planar member causes the resistive force on the third generally planar member.

11. An apparatus for forming a culm comprising:
a first elongated member on which a first generally planar member is connected along a first plane;
a second elongated member on which a second generally planar member is connected along a second plane, the second generally planar member slidingly engaging the first generally planar member; and
an adjuster for exerting a first resistive force on the second generally planar member, the adjuster disposed on the first elongated member.

12. The apparatus of claim 11, wherein the adjuster adjusts the magnitude of the resistive force.

13. The apparatus of claim 11, wherein the adjuster comprises a first bottom edge surface and wherein the first generally planar member comprises a second bottom edge surface, and wherein the first bottom edge surface of the adjuster is offset from the second bottom edge surface of the first generally planar member.

14. The apparatus of claim 13, wherein the offset between the first bottom edge surface of the adjuster and the second bottom edge surface of the first generally planar member causes the resistive force on the second generally planar member.

15. The apparatus of claim 11, wherein the adjuster comprises a third generally planar member, the third generally planar member being disposed along a third plane that is substantially parallel to the first plane.

16. A method for forming a multisided culm, the method comprising:
positioning a first corner form and a second corner form around a culm to form a multisided form around the culm;
causing the first corner form to exert a resistive force on the second corner form; and
adjusting the magnitude of the resistive force.

17. The method of claim 16, wherein the multisided form is positioned to be smaller than an expected maximum diameter of the culm.

18. The method of claim 16, wherein the culm expands during growth and causes the multisided form to expand.

19. The method of claim 16, wherein the resistive force causes a frictional force between the first corner form and the second corner form, wherein the frictional force resists expansion of the multisided form.

20. The method of claim 16, further comprising squaring the multisided form.
